(19) United States
(12) Patent Application Publication
(10) Pub. No.: US 2002/0126011 A1
(43) Pub. Date: Sep. 12, 2002

(54) Newspaper box monitor

(76) Inventor: Deane Dorwin McMillen, Willshire, OH (US)

Correspondence Address: Deane Dorwin McMillen, Box 201, 507 Hogan Street, Willshire, OH, 45898, US

(21) Appl. No.: 09/756,345

(22) Filed: Apr. 24, 2001

Related U.S. Application Data
(60) Provisional application No. 60/179,444, filed on Feb. 1, 2000.

(51) Int. Cl. G08B 13/14

(52) U.S. Cl. 340/569; 340/570; 340/568.1

(57) ABSTRACT

A mechanical lever, a microswitch, and visual monitor with blinking light, or transmitter monitor with a receiver in the house, mounted into an existing newspaper company's newspaper box.

### CROSSREFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

All newspaper companies will install a newspaper box to a street or a road at your property and deliver the newspaper to that newspaper box every day that they print the newspaper. the time of the delivery can vary from day to day for a variety of reasons. Without a device to determine when the newspaper has been delivered, one could check several times before finding that the newspaper has arrived.

### BRIEF SUMMARY OF THE INVENTION

With a newspaper monitor a homeowner would not have to leave his or her home or waste time by having to watch for the delivery person to drive up and put the newspaper into the newspaper box.

### BRIEF DESCRIPTION OF SEVERAL VIEWS OF THE DRAWINGS

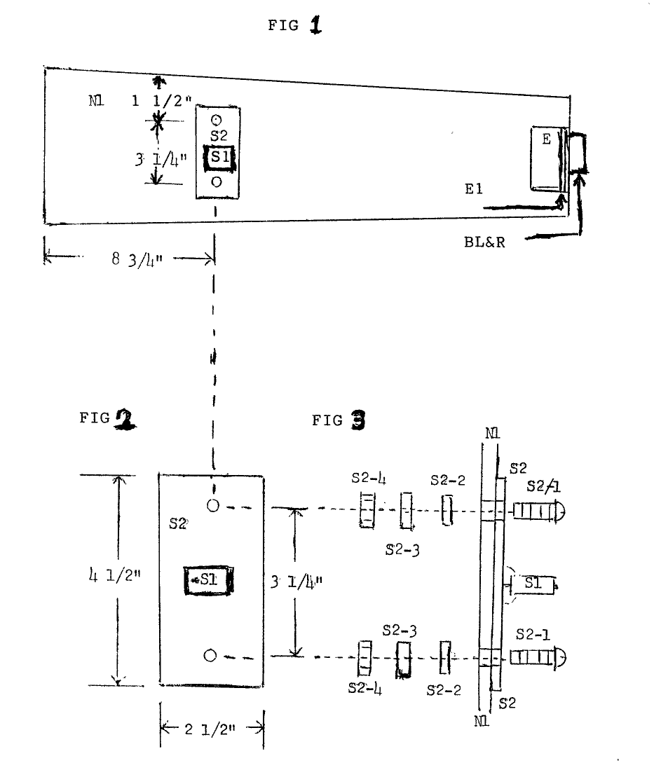

Drawing 1/4 shows FIG. 1, FIG. 2, FIG. 3. FIG. 1 gives the deminsions from the front and sides of the bottom (N1) of the newspaper box, to drill two 9/64″ mounting holes for the micro-switch mounting plate (S2) FIG. 2. FIG. 2 shows the microswitch (S1) fastened to the microswitch mounting plate (S2). FIG. 3 shows the sequence and the fasteners and how it is fastened.

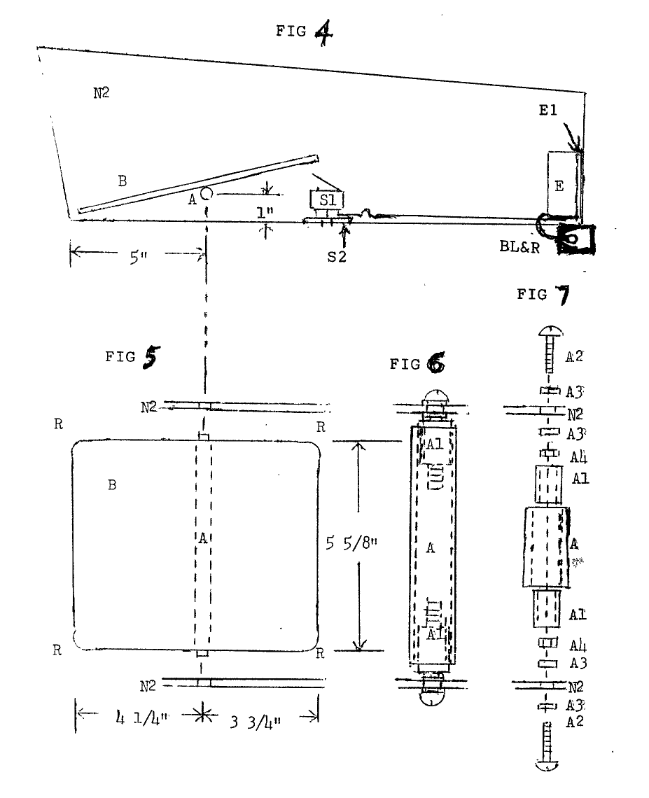

Drawing 2/4 shows FIG. 4, FIG. 5, FIG. 6, and FIG. 7. FIG. 4 shows the completed newspaper box with the dimensions from the front and the bottom, where to drill one 9/64″ hole on each side of the newspaper box (N2) and where to mount the lever (B) FIG. 5 that activates the microswitch (SI) FIG. 4. FIG. 5 shows the dimensions of the lever (B), the ½″ radius on the corners (R), and where counterweights (C) are fastened on the back side and and the bottom of the lever (B). FIG. 6 (A) is mounted on the bottom of the lever (B) the measured distance at FIG. 5 (A). FIG. 7 shows the appropriate fastners and parts and how it is fastened to FIG. 4 (N2).

Drawing 3/4 shows a schematic diagram with electronic parts, to be mounted to a circuit board, to make a visual news=paper box monitor that is installed into an enclosure box (E). It is fastened into the back of the newspaper box and wired to a light bulb, lens and reflector (BL&R), fastened to the bottom and the back of the newspaper box, and adjusted so you can see it from the house. When a newspaper is delivered you would see a blinking light at the newspaper box.

Drawing 4/4 shows a schematic diagram with electronic parts, to be mounted to a circuit board, to make a transmitter newspaper box monitor that is installed into an enclosure box (E). (if you would chose to have a transmitter monitor instead of a visual monitor). It would be installed into the back of the newspaper box. You must have a receiver inside the house to have this installation. It would make intermittent audio sounds in the house when the newspaper is delivered.

### DETAILED DESCRIPTION OF THE INVENTION

Drawing 1/4 shows FIG. 1, FIG. 2, and FIG. 3. FIG. 1 gives the dimensions from the front and sides of an existing newspaper box (N1) bottom, to drill two 9/64″ mounting holes for mounting a (S2) microswitch mounting plate with a (S1) microswitch attached. FIG. 2 gives the dimensions for making a (S2) microswitch mounting plate, made from a copper clad phenolic board, plastic, aluminum, or other material. FIG. 3 shows the (S1) microswitch fastened to the (S2) microswitch plate and to the holes drilled in the (N1) bottom of the newspaper box FIG. 1, with fasteners (S2-1) machine screws #6-32×¾″ long, and fasteneed down with (S2-2) #6 washers, (S2-3) #6 lock washers, and (S2-4) #6 nuts.

DRAWING 2/4 shows FIG. 4, FIG. 5, FIG. 6, and FIG. 7. FIG. 4 shows dimensions to drill two 9/64″ holes for mounting levor (B) that activates the microswitch (S1), when the newspaper is delivered. FIG. 5 shows the dimensions of lever (B) with ½″ radius (R) on the 4 corners, and where counterweights (C) are fastened to the back side and the bottom of lever (B). FIG. 6(A) is mounted on the bottom of lever (B), the measured distance in FIG. 5 (A).

FIG. 7 shows how the lever (B) is in sequence from both sides. (A) ⅜″ OD plastic, polybutylene,aluminum, or copper tubing 5 ⅝″ long, (Al) 1″long bearings or #6 spacers inserted into each end of (A) with ⅛″ sticking out, total length 5 ⅞″ long. (A2) machine screws #6-32×2 ½″ long, (A3) #6 washers, (N2) side of newspaper box, (A3) #6 washers, (A4) #6 nuts. Do the same on both sides of (A) FIG. 7 when mounting into FIG. 4 at (A).

Drawing 3/4 is a schematic for a visual newspaper box monitor. The Resistors are in Ohms—¼ Watt—5 percent: R1—1 megohm: R2—33000: R3—1000: R4—27: The Capacitors are in Microfarads: C1—4.7 Electrolytic: C2—0.05 Disc: IC 1—Lm555 Timer: Q1—2N 3906 PNP Transistor: S1 Microswitch: BL&R—Bulb—6 Volt, 25 Ma—Lens & Reflector: Circuit Board: B1—9 Volt Battery: E—Enclosure:

The IC 1 timer/osc, (LM555) is used to time the on-off time of the Bulb. Timing is done by the values of R1, R2 and C1. The output of IC 1, pin 3, is applied to the base of Q1 (2N3906-PNP transistor), which makes the bulb blink on and off. When the newspaper is delivered the weight of the newspaper on the lever (B) will activate the microswitch (S1) and put a negative voltage to pin 1 of the IC 1 timer, turning it on, and the bulb can be seen blinking on and off fron the house.

Drawing 4/4 is a schematic for a transmitter newspaper box monitor.The Resistors are in Ohms—¼ Watt—5 percent: the Capacitors are in Microfarads, except C5 & C6 are in pecofarads: R1—47000: R2—10000: R3—240: R4—10000: R5—5600: R6—120: C1—0.05 Disc: C2—0.01 Disc: C3—0.01 Disc: C4 0.005 Disc: C5—40 PF—variable—3 PF to 40 PF: C6—5 PF Disc: C7—0.1 Disc: IC 1—LM555 Timer: Q1—2N3904 NPN Transistor: S1 Microswitch: L1 Antenna—Center Tapped: Circuit Board: E—Enclosure: B1—9 Volt Battery:

The IC 1 timer (LM555) is used as an audio signal gener=tor. The audio frequency is determined by the value of R1, R2, and Cl. The audio output at pin 3 is applied to the base of Q1 (2N3904) through C3 and R3 and modulates the frequency of the Q1 oscillator. The frequency of Q1 is determined by the value of the coil L1 (4 turns #22 AWG enameled wire ¼″ plastic form-antenna center tapped) and the variable capacitor C5. By adjusting C5 the frequency can be changed. The weight of the newspaper on the lever (B), when the newspaper is delivered, will activate the microswitch (S1) and turn on the 9 volt transmitter.

A FM reciever in the house, when tuned to the transmitter frequency, will make an audio tone in the speaker. The transmitter frequency can be changed by adjusting the variable capacitor C5 and should be set on an unused point on the reciever in your area.

What I claim as my invention is

1. A Newspaper Box Monitor, so I can tell by looking from the house, for a blinking light with a visual monitor, or listening for an intermittent audio sound in the house, with a transmitter monitor in the newspaper box and a receiver in the house, without going out to the newspaper box at the street, to see if a newspaper has been deliverd.
